(19) United States
(12) Patent Application Publication
(10) Pub. No.: US 2004/0263055 A1
(43) Pub. Date: Dec. 30, 2004

(54) Electrode substrate of flat panel display

(76) Inventors: Chin-Hsiao Chao, Hsinchu City (TW); Tien-Wang Huang, Taoyuan (TW); Yih Chang, Jhonghe City (TW); Chin-To Chen, Tainan County (TW); Wei-Cheng Lih, Tainan County (TW)

Correspondence Address: BIRCH STEWART KOLASCH & BIRCH, PO BOX 747, FALLS CHURCH, VA, 22040-0747, US

(21) Appl. No.: 10/876,470

(22) Filed: Jun. 28, 2004

(30) Foreign Application Priority Data
Jun. 30, 2003 (TW) 092117863

(51) Int. Cl. H01J 1/05; H01J 1/14; H01J 1/62

(52) U.S. Cl. 313/495; 313/311

(57) ABSTRACT

An electrode substrate of a flat panel display comprises a substrate, an electrode layer, a conductive layer, and a barrier layer. In this case, the electrode layer is disposed above the substrate. The conductive layer is disposed above the electrode layer. The material of the conductive layer comprises Silver (>99.5%), Silver alloy, Aluminum (>99.5%), Aluminum alloy, Copper (>99.5%) or Copper alloy. The barrier layer is disposed above the conductive layer. The material of the barrier layer comprises Titanium, Titanium alloy, Molybdenum, Chromium, Silicon, Silicon Oxide, or Titanium Oxide.

### BACKGROUND OF THE INVENTION

1. Field of Invention

The invention relates to an electrode substrate and, in particular, to an electrode substrate of a flat panel display.

2. Related Art

Referring to FIG. 1, the currently used electrode substrate 4 of a flat panel display comprises a substrate 41, an electrode layer 42, and a conductive layer 43. Wherein, the electrode layer 42 is disposed on the substrate 41 and the conductive layer 43 is disposed on the electrode layer 42. In this case, the material of the conductive layer 43 is selected from low resistance metals or alloys, such as Silver (>99.5%), Silver alloy, or Aluminum alloy.

In the manufacturing processes of the flat panel display, an etchant is applied to etch the conductive layer 43 of the electrode substrate 4, into the actually required pattern of conductive lines or the pattern of auxiliary conductive lines. As shown in FIG. 2, a photoresist layer 5 is disposed on the conductive layer 43 (such as Silver alloy), and a patterned mask 6 is then disposed above the photoresist layer 5. In the meanwhile, a ultra-violet light (UV light) illuminates the patterned mask 6 and the photoresist layer 5. Thereafter, a development step is performed. Finally, the etchant is used to etch the conductive layer 43 into the required pattern of the conductive lines 431, as shown in FIG. 3.

At present time, before forming the photoresist layer 5, the UV light irradiation is applied to the surface of the conductive layer 43. By this way, the adhesive force between the photoresist layer 5 and the conductive layer 43 will be improved and it can prevent the peeling of photoresist 5 and conductive layer 43 in the following processes, which will lower the yield of the product.

However, owing to being irradiated, the conductive layer 43 is easily oxidized (dark color) and results in the resistance rising of the conductive layer 43 and the adhesive force decreasing with the photoresist layer 5. Besides, the thickness of the conductive layer 43 is about 4000˜6000 Å, when proceeding the etching process, it's difficult to control the shape of the conductive line, in another word, referring to FIG. 3, the etched portion of the conductive layer 43 near the photoresist layer 5 is larger than the etched portion of the bottom of the conductive layer 43 (near the electrode layer 42). It makes the electron migration and shorting happen easily between the bottom of the adjacent conductive lines, and results in decreasing the reliability of the device.

Generally speaking, the metal conductive lines of the active matrix flat panel display (such as AM-LCD) are made of some transition metals, e.g. Molybdenum (Mo), Chromium (Cr), or Tantalum (Ta). During the manufacturing process of the conductive metal lines, a better step-coverage of the thin film and a low thickness of the thin film are required. However, the thin metal conductive line will render the resistance of the conductive line become higher, which lead to a higher RC-delay signal. As a result, the size of the flat panel display made by these transition metals is restricted. For manufacturing large size flat panel displays, it's important to develop the ultra-low resistance material or process for conductive metal line.

In the view of manufacturing the metal conductive lines, for lower resistance, it has to use a thicker and/or wider metal thin film. The disadvantage of the thicker metal thin film is there will induce the worse step-coverage and the pinhole formation. At present, the disadvantage is improved by using specific taper etching process, but it will increase the cost of the processes. Moreover, the wider metal thin film will decrease the aspect ratio of the pixels, and will increase the parasitic capacitance of the conductive line. As a result, thicker and/or wider metal thin film manufacturing process doesn't work out.

During the processes of manufacturing the TFT-LCD (thin film transistor liquid crystal display), the tri-layered structure of chromium/aluminum/chromium or molybdenum/aluminum/molybdenum is used to avoid the mentioned problems. However, manufacturing this kind of conductive line, it must use two different kinds of etchant solutions. At the beginning, the first etchant solution is employed to etch the upper chromium (or molybdenum) metal layer, and then second etchant solution is employed to etch the middle aluminum metal layer. Finally, the first etchant solution is employed again to etch the bottom chromium (or molybdenum) metal layer. As a result, there should be three times of etching steps to do. Not only the manufacturing steps are complicated, but also the cost of them is increased, so it is not practical to provide this process to the industrial application.

As described above, it is important to provide an electrode substrate for flat panel display for solving the above-mentioned problems.

### SUMMARY OF THE INVENTION

In view of the above-mentioned problems, the invention is provided an electrode substrate of a flat panel display, which has a barrier layer. The barrier layer can prevent the conductive layer from being oxidized easily, and also can control the shape of the etched conductive line.

To solve the above-mentioned problems, an electrode substrate of a flat panel display of the invention comprises a substrate, an electrode layer, a conductive layer, and a barrier layer. In this invention, the electrode layer is disposed above the substrate. The conductive layer is disposed above the electrode layer. The material of the conductive layer comprised Silver (>99.5%), Silver alloy, Aluminum (>99.5%), Aluminum alloy, Copper (>99.5%) or Copper alloy. The barrier layer is disposed above the conductive layer, and made of Titanium or Titanium alloy.

The invention also provides an electrode substrate of a flat panel display, which comprises a substrate, an electrode layer, a conductive layer, and a barrier layer. The electrode is disposed above the substrate. The conductive layer is disposed above the electrode layer, and the material of the conductive layer comprised Silver (>99.5%), Silver alloy, Aluminum (>99.5%), Aluminum alloy, Copper (>99.5%) or Copper alloy. The barrier layer is disposed above the conductive layer, and made of Molybdenum, Chromium, Silicon, Silicon Oxide or Titanium Oxide.

The invention further provides an electrode substrate of a flat panel display, which comprises a substrate, an electrode layer, a conductive line pattern, and a barrier layer. The electrode is disposed above the substrate. The conductive line pattern is disposed above the electrode layer, and has at least one conductive line, wherein, the angle formed by the lateral side of the conductive line and the electrode layer is about 90 degree, and the conductive line pattern is made of Silver (>99.5%), Silver alloy, Aluminum (>99.5%), Aluminum alloy, Copper (>99.5%) or Copper alloy. The barrier layer is disposed above the conductive line pattern.

In the invention, the flat panel display includes, but not limited to, an organic electroluminescent (OEL) display, an electroluminescent (EL) display, a light-emitting diode (LED) display, a liquid crystal display (LCD), a plasma display panel (PDP), a vacuum fluorescent display (VFD), a field emission display (FED), or an electro-chromic display.

As mentioned above, the invention provides an electrode substrate of a flat panel display, which has a barrier layer to protect the conductive layer and the electrode layer. Comparing to the prior art, the barrier layer of the invention may prevent the conductive layer from being oxidized owing to the illumination of the UV light. It may decrease the raise of the resistance of the conductive line layer; moreover, it also may increase the adhesion force with the photoresist layer. The invention may further control the shape of the etched conductive line (such as the angle disposed by the lateral side of the conductive layer and the electrode layer is about 90 degree) and may prevent the conductive line from electron migration. By this way, it can also avoid the shorting, which can ensure the reliability of the products. On the other hand, when the barrier layer is made of Titanium or Titanium alloy, only one etchant solution is needed, and only one etching step is proceeding to simultaneously etch the barrier layer and the electrode layer. Moreover, the invention not only has simple manufacturing processes, but also the cost is reduced. So it is very proper to apply the invention to industrial application.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional electrode substrate;

FIG. 2 and FIG. 3 are schematic cross-sectional views of forming the conductive line or auxiliary conductive line on the conventional electrode substrate;

FIG. 4 is a cross-sectional view of the electrode substrate according to the first embodiment of the invention;

FIG. 5 is a cross-sectional view of forming the conductive line or auxiliary conductive line on the electrode substrate according to the first embodiment of the invention;

FIG. 6 is a cross-sectional view of the electrode substrate according to the second embodiment of the invention; and

FIG. 7 is a cross-sectional view of the electrode substrate according to the third embodiment of the invention.

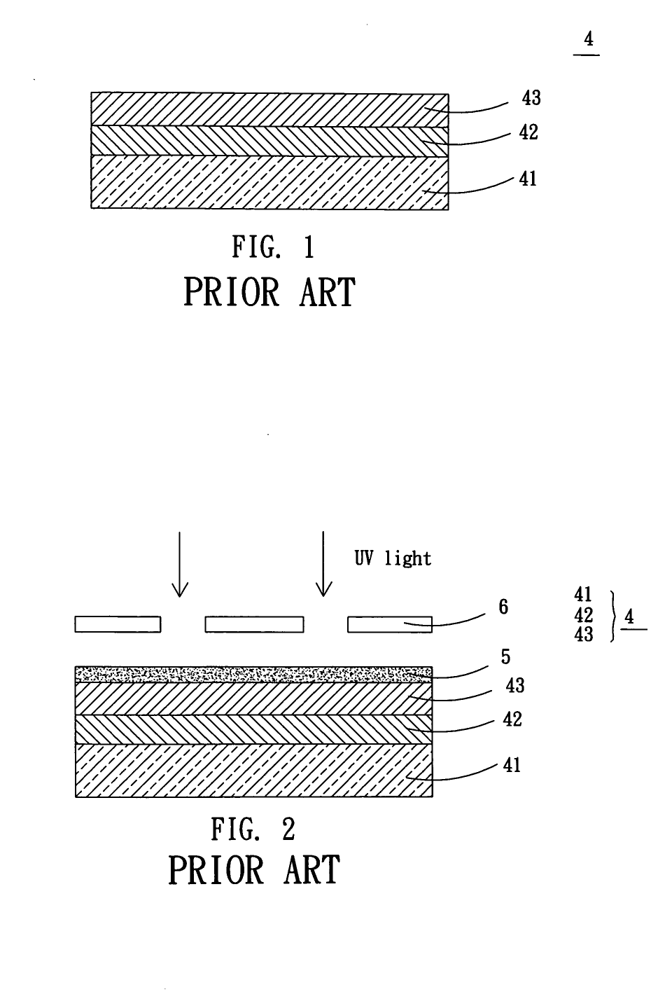

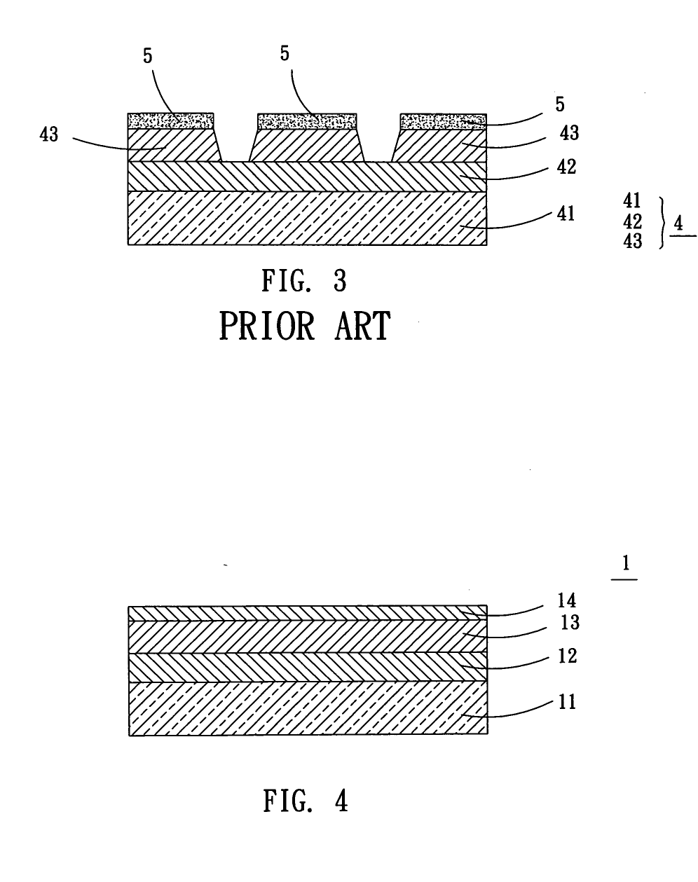

### DETAILED DESCRIPTION OF THE INVENTION

The electrode substrate of flat panel displays according to preferred embodiments of the invention will be described herein below with reference to the accompanying drawings, wherein the same reference numbers refer to the same elements.

Referring to FIG. 4, according to the first embodiment of the invention, an electrode substrate 1 of a flat panel display comprises a substrate 11, an electrode layer 12, a conductive layer 13, and a barrier layer 14. In this invention, the electrode layer 12 is disposed above the substrate 11. The conductive layer 13 is disposed above the electrode layer 12. The barrier layer 14 is disposed above the conductive layer 13, and is made of Titanium or Titanium alloy.

In the current embodiment, the substrate 11 can be a flexible substrate or a rigid substrate. The substrate 11 can also be a plastic substrate or a glass substrate. In particular, the flexible substrate or plastic substrate can be made of polycarbonate (PC), polyester (PET), cyclic olefin copolymer (COC), metallocene-based cyclic olefin copolymer (mCOC), or a thin glass.

Besides, as shown in FIG. 4, the electrode layer 12 is disposed on the substrate 11. In the present embodiment, the electrode layer 12 is disposed on the substrate 11 by way of sputtering or ion plating. The electrode layer 12 is made of a conductive metal oxide, such as Indium-Tin Oxide (ITO), Aluminum-Zinc Oxide (AZO), or Indium-Zinc Oxide (IZO).

Referring to FIG. 4 again, the conductive layer 13 of the current embodiment is disposed on the electrode layer 12. The conductive layer 13 is made of Silver (>99.5%), Silver alloy, Aluminum (>99.5%), Aluminum alloy, Copper (>99.5%) or Copper alloy. Because of the low resistance and high conductivity of above metals, they are very suitable to be made as conductive lines. The conductive layer 13 has a thickness of 4000˜6000 Å.

As shown in FIG. 4, the barrier layer 14 of the current embodiment is disposed on the conductive layer 13. The barrier layer 14 is used to protect the conductive layer 13 and the electrode layer 12, and prevent the conductive layer 13 from oxidation after irradiating to the UV light. In this case, the barrier layer 14 is made of Titanium or Titanium alloy. Because both of the Titanium and Titanium alloy are active metals, after the barrier layer 14 is patterned, the adhesion between the barrier layer 14 and the driving IC (not shown in this figure) will become better than the adhesion between the conductive layer 13 (e.g. Silver alloy) and the driving IC. In addition, a thin and dense oxide layer (e.g. Titanium Oxide), which is a good etch-resist material, is formed on the surface of the Titanium. The barrier layer 14 has a thickness below 100 Å.

In the current embodiment, the thickness of conductive layer 13 and the barrier layer 14 is adjustable and depended on the practical condition.

When forming the pattern of the conductive line or the auxiliary conductive line, the first step is to coat a photoresist layer on the barrier layer 14, followed by providing a patterned mask on the photoresist layer and irradiating under the UV light. Then, proceeding the development step to form the patterned photoresist layer, and using the etchant solution to proceed the etching step.

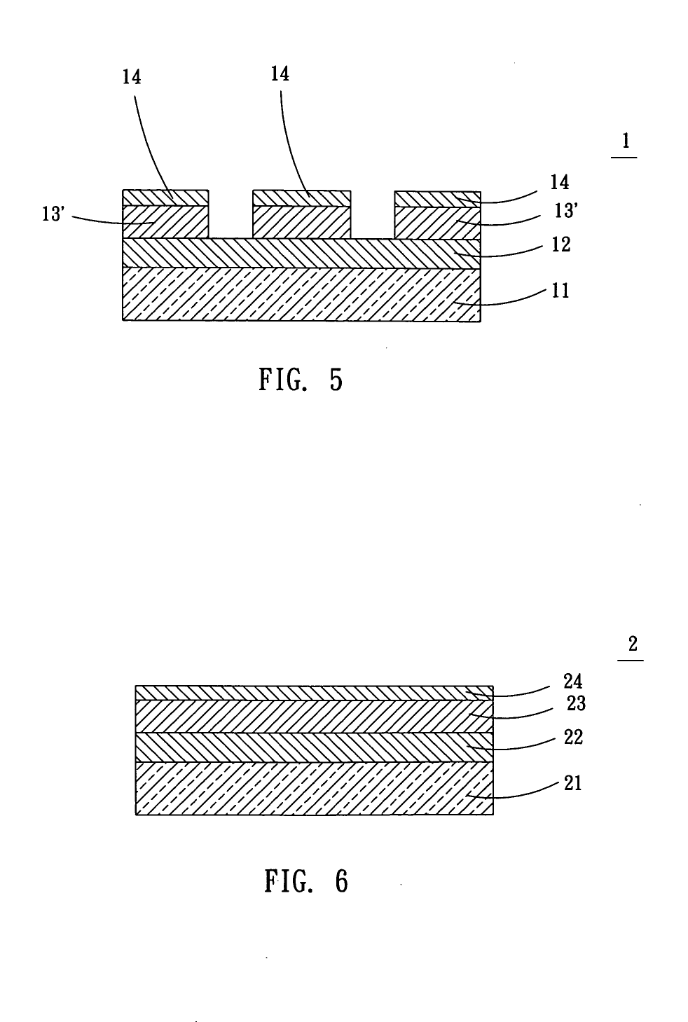

According to FIG. 5, in the current embodiment, by controlling and adjusting the thickness of the barrier layer 14 and the etching factors, the shape of the conductive line 13′ can be controllable after etching the conductive layer 13, such as the angle between the conductive line 13′ and the electrode layer 12 is about 90 degree. In this way, the shorting due to the electron migration in the bottom of the conductive line 13′ can be prevented. Besides, when proceeding the etching step, only one etchant solution is needed, and can etch the barrier layer 14 and the conductive layer 13, which means there is only one etching step needed to etch the barrier layer 14 and the conductive layer 13. Moreover, other patterns can be formed by the same way on the electrode substrate 1.

As shown in FIG. 6, the electrode substrate 2 according to the second embodiment of the invention comprises a substrate 21, an electrode layer 22, a conductive layer 23, and a barrier layer 24. The electrode layer 22 is disposed above the substrate 21. The conductive layer 23 is disposed above the electrode layer 22, and is made of Silver (>99.5%), Silver alloy, Aluminum (>99.5%), Aluminum alloy, Copper (>99.5%) or Copper alloy. The barrier layer is disposed above the conductive layer, and is made of Molybdenum, Chromium, Silicon, Silicon Oxide or Titanium Oxide.

In this embodiment, the substrate 21, the electrode layer 22, and the conductive layer 23 are the same as the substrate 11, the electrode layer 12, and the conductive layer 13 mentioned in the first embodiment.

In this embodiment, the barrier layer 24 is made of Molybdenum, Chromium, Silicon, Silicon Oxide or Titanium Oxide, and the other features or functions are the same as the previously mentioned in the first embodiment.

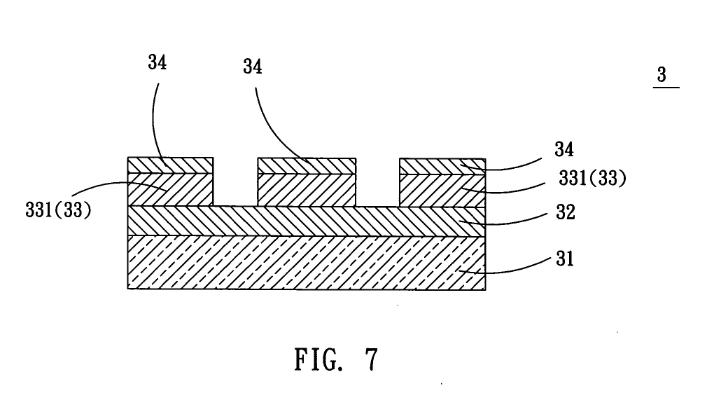

Referring to FIG. 7, the third embodiment of the invention further provides an electrode substrate 3, which comprises a substrate 31, an electrode layer 32, a conductive line pattern 33, and a barrier layer 34. The electrode layer 32 is disposed above the substrate 31. The conductive line pattern 33 is disposed above the electrode layer 32, and has at least one conductive line 331, wherein, the angle formed by the lateral side of the conductive line 331 and the electrode layer 32 is about 90 degree, and the conductive line pattern 33 is made of Silver (>99.5%), Silver alloy, Aluminum (>99.5%), Aluminum alloy, Copper (>99.5%) or Copper alloy. The barrier layer 34 is disposed above the conductive line pattern 33.

In this embodiment, the substrate 31, the electrode layer 32, and the conductive layer 33 are the same as the substrate 11, the electrode layer 12, and the conductive layer 13 mentioned in the first embodiment.

In this embodiment, the barrier layer 34 is made of Molybdenum, Chromium, Silicon, Silicon Oxide or Titanium Oxide, and the other features or functions are the same as the barrier layer 14 mentioned in the first embodiment.

In the invention, the flat panel display includes, but not limited to, an organic electroluminescent (OEL) display, an electroluminescent (EL) display, a light emitting diode (LED), a liquid crystal display (LCD), a plasma display panel (PDP), a vacuum fluorescent display (VFD), a field emission display (FED), or an electro-chromic display and so on.

As mentioned above, the invention provides an electrode substrate of a flat panel display, which has a barrier layer to protect the conductive layer and the electrode layer. Comparing to the prior art, the barrier layer of the invention may prevent the conductive layer from being oxidized owing to the illumination of the UV light. It may decrease the raise of the resistance of the conductive line layer; moreover, it also may increase the adhesion force with the photoresist layer. The invention may further control the shape of the etched conductive line (such as the angle disposed by the lateral side of the conductive layer and the electrode layer is about 90 degree) and may prevent the conductive line from electron migration. By this way, it can also avoid the shorting, which can ensure the reliability of the products. On the other hand, when the barrier layer is made of Titanium or Titanium alloy, only one etchant solution is needed, and only one etching step is proceeding to simultaneously etch the barrier layer and the electrode layer. Moreover, the invention not only has simple manufacturing processes, but also the cost is reduced. So it is very proper to apply the invention to industrial application.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electrode substrate of a flat panel display, comprising:
a substrate;
an electrode layer, which is disposed above the substrate;
a conductive layer, which is disposed above the electrode layer, and made of Silver (>99.5%), Silver alloy, Aluminum (>99.5%), Aluminum alloy, Copper (>99.5%) or Copper alloy; and
a barrier layer, which is disposed above the conductive layer, and made of Titanium or Titanium alloy.

2. The electrode substrate according to claim 1, wherein the substrate is at least one selected from the group consisting of rigid substrate, glass substrate, plastic substrate, and flexible substrate.

3. The electrode substrate according to claim 1, wherein the electrode layer comprises a conductive metal oxide electrode layer.

4. The electrode substrate according to claim 3, wherein the electrode layer is at least one selected form the group consisting of Indium-Tin Oxide electrode, Aluminum-Zinc Oxide electrode, and Indium-Zinc Oxide electrode.

5. The electrode substrate according to claim 1, wherein the thickness of the conductive layer is about 4000˜6000 Å.

6. The electrode substrate according to claim 1, wherein the thickness of the barrier layer is less than 100 Å.

7. An electrode substrate of a flat panel display, comprising:
a substrate;
an electrode layer, which is disposed above the substrate;
a conductive layer, which is disposed above the electrode layer, and made of Silver (>99.5%), Silver alloy, Aluminum (>99.5%), Aluminum alloy, Copper (>99.5%) or Copper alloy; and
a barrier layer, which is disposed above the conductive layer, and made of Molybdenum, Chromium, Silicon, Silicon Oxide or Titanium Oxide.

8. The electrode substrate according to claim 7, wherein the substrate is at least one selected from the group consisting of rigid substrate, glass substrate, plastic substrate, and flexible substrate.

9. The electrode substrate according to claim 7, wherein the electrode layer comprises a conductive metal oxide electrode layer.

10. The electrode substrate according to claim 9, wherein the electrode layer is at least one selected form the group consisting of Indium-Tin Oxide electrode, Aluminum-Zinc Oxide electrode, and Indium-Zinc Oxide electrode.

11. The electrode substrate according to claim 7, wherein the thickness of the conductive layer is about 4000˜6000 Å.

12. The electrode substrate according to claim 7, wherein the thickness of the barrier layer is less than 100 Å.

13. An electrode substrate of a flat panel display, comprising:
a substrate;
an electrode layer, which is disposed above the substrate;
a conductive line pattern, which is disposed above the electrode layer, and has at least one conductive line, wherein, the angle disposed by the lateral side of the conductive line and the electrode layer is about 90 degree, and the conductive line pattern is made of Silver (>99.5%), Silver alloy, Aluminum (>99.5%), Aluminum alloy, Copper (>99.5%) or Copper alloy; and
a barrier layer, which is disposed above the conductive line pattern.

14. The electrode substrate according to claim 13, wherein the barrier layer is made of Titanium or Titanium alloy.

15. The electrode substrate according to claim 13, wherein the barrier layer is made of Molybdenum, Chromium, Silicon, Silicon Oxide or Titanium Oxide.

16. The electrode substrate according to claim 13, wherein the substrate is at least one selected from the group consisting of rigid substrate, glass substrate, plastic substrate, and flexible substrate.

17. The electrode substrate according to claim 13, wherein the electrode layer comprises a conductive metal oxide electrode layer.

18. The electrode substrate according to claim 17, wherein the electrode layer is at least one selected form the group consisting of Indium-Tin Oxide electrode, Aluminum-Zinc Oxide electrode, and Indium-Zinc Oxide electrode.

19. The electrode substrate according to claim 13, wherein the thickness of the conductive line pattern is about 4000˜6000 Å.

20. The electrode substrate according to claim 13, wherein the thickness of the barrier layer is less than 100 Å.
